(19) United States
(12) Patent Application Publication
(10) Pub. No.: US 2025/0392390 A1
(43) Pub. Date: Dec. 25, 2025

(54) SIGNAL PROCESSING APPARATUS, SIGNAL PROCESSING METHOD, AND COMPUTER PROGRAM

(71) Applicant: NIPPON TELEGRAPH AND TELEPHONE CORPORATION, Tokyo (JP)

(72) Inventors: Akira KAWAI, Musashino-shi (JP); Masanori NAKAMURA, Musashino-shi (JP); Minami TAKAHASHI, Musashino-shi (JP); Takayuki KOBAYASHI, Musashino-shi (JP); Yutaka MIYAMOTO, Musashino-shi (JP)

(73) Assignee: NIPPON TELEGRAPH AND TELEPHONE CORPORATION, Tokyo (JP)

(21) Appl. No.: 18/992,296

(22) PCT Filed: Jul. 11, 2022
(86) PCT No.: PCT/JP2022/027220

§ 371 Date: Jan. 8, 2025

(51) Int. Cl. H04B 10/2507; H04B 10/61; H04J 14/06

(52) U.S. Cl. CPC H04B 10/2507; H04B 10/61; H04J 14/06

(57) ABSTRACT

Provided is a signal processing device including: a batch adaptive equalization unit configured to use a first adaptive filter to perform an equalization process of waveform distortion on each polarized digital signal obtained by performing analog-to-digital conversion on a polarization-multiplexed signal; a matrix conversion unit configured to acquire filter coefficients of the first adaptive filter from at least the batch adaptive equalization unit, and convert acquired the filter coefficients through matrix operation; a degree-of-freedom separation adaptive equalization unit configured to use a second adaptive filter including the filter coefficients converted by the matrix conversion unit to perform an equalization process of waveform distortion due to polarization state fluctuation in a transmission path on each polarized digital signal; and a switching control unit configured to select a signal equalized by the batch adaptive equalization unit or the degree-of-freedom separation adaptive equalization unit as a reception signal.

### TECHNICAL FIELD

The present invention relates to a signal processing device, a signal processing method, and a computer program.

### BACKGROUND ART

Optical communications using optical fibers (hereinafter referred to as “optical transmission systems”) have the advantages of a wide usable frequency band and low signal attenuation. Therefore, optical transmission systems are capable of long-distance and large-capacity communication, and are widely used in modern fixed lines. In optical transmission systems, high-reliability optical communications are realized by using digital signal processing to compensate for signal distortion occurring in optical transceivers or optical fiber transmission paths.

In recent years, long-distance and large-capacity optical fiber transmission systems generally adopt polarization multiplex transmission in which independent signals are transmitted for each polarization component of light. In polarization multiplex transmission, dynamic polarization state fluctuations such as polarization rotation and polarization mode dispersion in an optical fiber transmission path cause interference between symbols, which limits transmission capacity. On the other hand, polarization multiplex transmission can be realized by compensating for dynamic polarization state fluctuations using 2×2 multiple input multiple output (MIMO) adaptive filter processing on a digital signal processing circuit on the reception end.

As a means of further increasing system capacity, an increase in capacity by increasing the signal symbol rate is being examined. However, in high symbol rate transmission, in addition to polarization state fluctuations. IQ waveform distortion occurring inside the transceiver, that is, distortion caused by a relative characteristic difference between in-phase components and quadrature components of a signal becomes a capacity limit factor. Examples of IQ waveform distortion include IQ skew which is a lane length difference between IQ lanes of a transceiver, amplitude or phase imbalance which is a difference in amplitude or phase characteristics, crosstalk between IQ lanes, and the like. Although IQ waveform distortion can also be compensated for with a fixed value by measuring its characteristics before the operation of the transceiver, there are practical advantages in adaptively compensating for the distortion because it fluctuates due to a change in the temperature of the transceiver and degradation over time.

Such IQ waveform distortion can also be compensated for by using an adaptive filter having a special configuration. Examples of such adaptive filters include a 4×2 MIMO configuration (see, for example, NPL 1) and an 8×2 MIMO configuration (see, for example, PTL 1). By increasing the internal degree of freedom of the adaptive part of the adaptive filter, the 4×2 MIMO configuration can compensate for IQ waveform distortion on the reception side and the 8×2 MIMO configuration can compensate for IQ waveform distortion on both the transmission and reception sides together with polarization state fluctuations.

### CITATION LIST

### Patent Literature

PTL 1: Japanese Patent Application Publication No. 2020-141294

### Non Patent Literature

NPL 1: R. Rios-Muller, J. Renaudier, and G. Charlet, “Blind Receiver Skew Compensation and Estimation for Long-Haul Non-Dispersion Managed Systems Using Adaptive Equalizer.” Journal of Lightwave Technology. Vol. 33, No. 7, pp. 1315-1318, 2015.

### SUMMARY OF INVENTION

### Technical Problem

However, the existing method in which the internal degree of freedom of the filter as described above is increased has a problem in that followability to dynamic polarization fluctuations is reduced as compared with conventional 2×2 MIMO. It known that, although IQ waveform distortion does not fluctuate rapidly, the polarization state of a transmission path configured with optical fibers fluctuates rapidly when electromagnetic or mechanical shocks generated during lightning strikes, facility construction, or the like are applied to the transmission path. For this reason, the adaptive filter must have followability corresponding to such rapid fluctuations in the polarization state caused by external factors.

However, in order to follow dynamic polarization fluctuations, it is necessary to increase the step size to be set when updating filter coefficients of the adaptive filter, but in the MIMO structure with increased degrees of freedom disclosed in NPL 1 and PTL 1, the number of traces of the covariance matrix of the input signal vector increases. Therefore, there is a problem in that the upper limit of the step size at which the filter operates stably is lowered, and when the step size is set beyond that limit, the filter coefficients will diverge to infinity. For this reason, in the past, there was a problem in that it was not possible to perform adaptive equalization having followability to rapid dynamic fluctuations in the polarization state while maintaining resistance to IQ waveform distortion of the transceiver.

In view of the above circumstances, an object of the present invention is to provide a technique that makes it possible to perform adaptive equalization having followability to rapid dynamic fluctuations in the polarization state originating from a transmission path while maintaining resistance to IQ waveform distortion of a transceiver.

### Solution to Problem

According to an aspect of the present invention, there is provided a signal processing device including: a batch adaptive equalization unit configured to use a first adaptive filter to perform an equalization process of waveform distortion on each polarized digital signal obtained by performing analog-to-digital conversion on a polarization-multiplexed signal; a matrix conversion unit configured to acquire filter coefficients of the first adaptive filter from at least the batch adaptive equalization unit, and convert acquired the filter coefficients through matrix operation; a degree-of-freedom separation adaptive equalization unit configured to use a second adaptive filter including the filter coefficients converted by the matrix conversion unit to perform an equalization process of waveform distortion due to polarization state fluctuation in a transmission path on each polarized digital signal; and a switching control unit configured to select a signal equalized by the batch adaptive equalization unit or the degree-of-freedom separation adaptive equalization unit as a reception signal.

According to an aspect of the present invention, there is provided a signal processing method including: using a first adaptive filter to perform an equalization process of waveform distortion on each polarized digital signal obtained by performing analog-to-digital conversion on a polarization-multiplexed signal; acquiring filter coefficients of at least the first adaptive filter and converting acquired the filter coefficients through matrix operation; using a second adaptive filter including the converted filter coefficients to perform an equalization process of waveform distortion due to polarization state fluctuation in a transmission path on each polarized digital signal; and selecting a signal that has undergone the equalization process using the first adaptive filter or the equalization process using the second adaptive filter as a reception signal.

According to an aspect of the present invention, there is provided a computer program for causing a computer to execute: using a first adaptive filter to perform an equalization process of waveform distortion on each polarized digital signal obtained by performing analog-to-digital conversion on a polarization-multiplexed signal; acquiring filter coefficients of at least the first adaptive filter and converting acquired the filter coefficients through matrix operation; using a second adaptive filter including the converted filter coefficients to perform an equalization process of waveform distortion due to polarization state fluctuation in a transmission path on each polarized digital signal; and selecting a signal that has undergone the equalization process using the first adaptive filter or the equalization process using the second adaptive filter as a reception signal.

### Advantageous Effects of Invention

According to the present invention, it is possible to perform adaptive equalization having followability to rapid dynamic fluctuation in the polarization state originating from a transmission path while maintaining resistance to IQ waveform distortion of a transceiver.

### BRIEF DESCRIPTION OF DRAWINGS

FIG. 1 A diagram illustrating a configuration example of a digital coherent optical transmission system in a first embodiment.

FIG. 2 A diagram illustrating an example of a configuration of a demodulation digital signal processing unit in the first embodiment.

FIG. 3 A diagram illustrating an overview of processing of the demodulation digital signal processing unit in the first embodiment.

FIG. 4 A diagram illustrating experimental results of the demodulation digital signal processing unit in the first embodiment.

### DESCRIPTION OF EMBODIMENTS

Hereinafter, an embodiment of the present invention will be described with reference to the accompanying drawings.

### First Embodiment

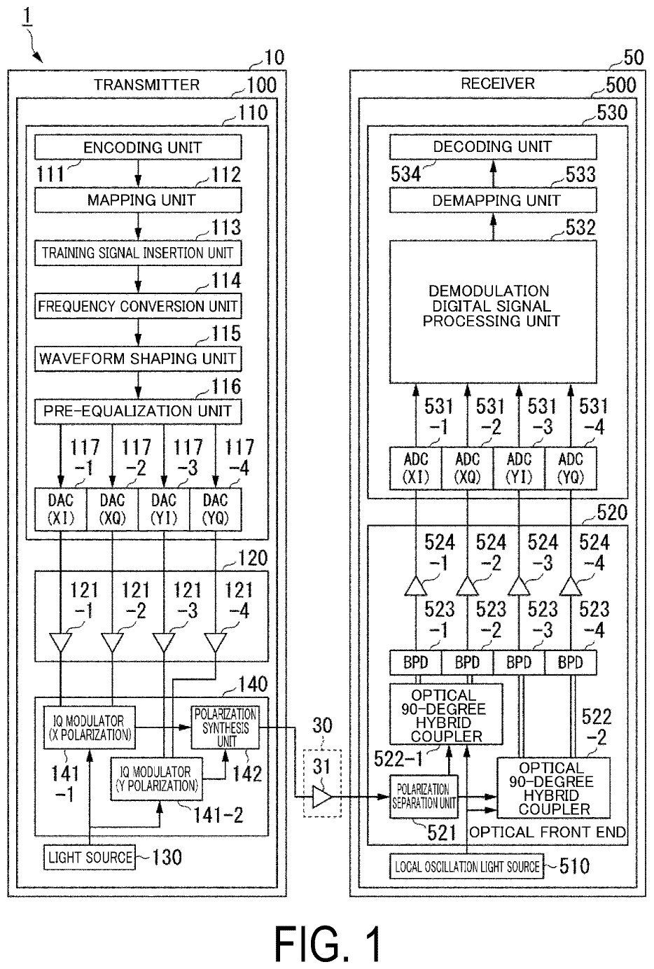

FIG. 1 is a diagram illustrating a configuration example of a digital coherent optical transmission system 1 in a first embodiment. The digital coherent optical transmission system 1 includes a transmitter 10 and a receiver 50. The transmitter 10 transmits a polarization-multiplexed signal. The receiver 50 receives the polarization-multiplexed signal from the transmitter 10.

First, the configuration of the transmitter 10 will be described.

The transmitter 10 includes a transmission unit 100. The transmission unit 100 outputs an optical signal having a specified wavelength to an optical fiber transmission path 30. The optical fiber transmission path 30 is equipped with one or more optical amplifiers 31. Each of the optical amplifiers 31 inputs an optical signal from the optical fiber transmission path 30 on the transmitter 10 side, amplifies the input optical signal, and outputs it to the optical fiber transmission path 30 on the receiver 50 side.

The transmission unit 100 includes a digital signal processing unit 110, a modulator driver 120, a light source 130, and an integration module 140. The digital signal processing unit 110 includes an encoding unit 111, a mapping unit 112, a training signal insertion unit 113, a frequency change unit 114, a waveform shaping unit 115, a pre-equalization unit 116, and digital-to-analog converters (DACs) 117-1 to 117-4.

The encoding unit 111 performs forward error correction (FEC) encoding on a transmission bit string and outputs an obtained transmission signal. The mapping unit 112 maps the transmission signal output from the encoding unit 111 into symbols. The training signal insertion unit 113 inserts a known training signal into the transmission signal symbol-mapped by the mapping unit 112. The frequency change unit 114 performs up-sampling by changing a sampling frequency for the transmission signal into the training signal is inserted. The waveform shaping unit 115 limits a band of the sampled transmission signal.

The pre-equalization unit 116 compensates for waveform distortion of the transmission signal of which the band is limited by the waveform shaping unit 115, and outputs it to the DACs 117-1 to 117-4. The DAC 117-1 converts an X-polarized I (in-phase) component of the transmission signal input from the pre-equalization unit 116 from a digital signal to an analog signal, and outputs it to the modulator driver 120. The DAC 117-2 converts an X-polarized Q (orthogonal) component of the transmission signal input from the pre-equalization unit 116 from a digital signal to an analog signal, and outputs it to the modulator driver 120. The DAC 117-3 converts a Y-polarized I component of the transmission signal input from the pre-equalization unit 116 from a digital signal to an analog signal, and outputs it to the modulator driver 120. The DAC 117-4 converts a Y-polarized Q component of the transmission signal input from the pre-equalization unit 116 from a digital signal to an analog signal, and outputs it to the modulator driver 120.

The modulator driver 120 includes amplifiers 121-1 to 121-4. The amplifier 121-i (i is an integer 1 between 4) amplifies the analog signal output from the DAC 117-i, and drives the modulator of the integration module 140 with the amplified analog signal. The light source 130 is, for example, a semiconductor laser (LD). The light source 130 outputs light of a specified wavelength.

The integration module 140 includes IQ modulators 141-1 and 141-2 and a polarization synthesis unit 142. The IQ modulator 141-1 outputs an X-polarized optical signal generated by modulating the optical signal output by the light source 130 using the X-polarized I component output from the amplifier 121-1 and the X-polarized Q component output from the amplifier 121-2. The IQ modulator 141-2 outputs a Y-polarized optical signal generated by modulating the optical signal output by the light source 130 using the Y-polarized I component output from the amplifier 121-3 and the Y-polarized Q component output from the amplifier 121-4. The polarization synthesis unit 142 generates a polarization-multiplexed signal by polarization-multiplexing the X-polarized optical signal output by the IQ modulator 141-1 and the Y-polarized optical signal output by the IQ modulator 141-2. The polarization synthesis unit 142 outputs the generated polarization-multiplexed signal to the optical fiber transmission path 30.

Next, the configuration of the receiver 50 will be described.

The receiver 50 includes a reception unit 500. The reception unit 500 receives the polarization-multiplexed signal propagated through the optical fiber transmission path 30. The reception unit 500 includes a local oscillation light source 510, an optical front end 520, and a digital signal processing unit 530. The local oscillation light source 510 is, for example, an LD. The local oscillation light source 510 outputs local oscillation light (LO).

The optical front end 520 converts the optical signal into an electrical signal while maintaining the phase and amplitude of the polarization-multiplexed signal. The optical front end 520 includes a polarization separation unit 521, optical 90-degree hybrid couplers 522-1 and 522-2, balanced photo diodes (BPDs) 523-1 to 523-4, and amplifiers 524-1 to 524-4.

The polarization separation unit 521 separates the input polarization-multiplexed signal into an X-polarized optical signal and a Y-polarized optical signal. The polarization separation unit 521 outputs the X-polarized optical signal to optical 90-degree hybrid coupler 522-1, and outputs the Y-polarized optical signal to the optical 90-degree hybrid coupler 522-2.

The optical 90-degree hybrid coupler 522-1 causes the X-polarized optical signal to interfere with the local oscillation light output from the local oscillation light source 510, and extracts the 1-component optical signal and the Q-component optical signal of the received optical electric field. The optical 90-degree hybrid coupler 522-1 outputs the extracted X-polarized I-component optical signal and Q-component optical signal to the BPDs 523-1 and 523-2.

The optical 90-degree hybrid coupler 522-2 causes the Y-polarized optical signal to interfere with the local oscillation light output from the local oscillation light source 510, and extracts the I component and the Q component of the received optical electric field. The optical 90-degree hybrid coupler 522-2 outputs the extracted Y-polarized I component and Q component to the BPD 523-3 and BPD 523-4.

The BPDs 523-1 to 523-4 are differential input type photoelectric converters. The BPD 523-i outputs a difference value of photocurrents generated in two photodiodes having uniform characteristics to the amplifier 524-i. The BPD 523-1 converts the I component of the X-polarized reception signal into an electrical signal, and outputs it to the amplifier 524-1. The BPD 523-2 converts the Q component of the X-polarized reception signal into an electrical signal, and outputs it to the amplifier 524-2. The BPD 523-3 converts the I component of the Y-polarized reception signal into an electrical signal, and outputs it to the amplifier 524-3. The BPD 523-4 converts the Q component of the Y-polarized reception signal into an electrical signal, and outputs it to the amplifier 524-4. The amplifier 524-i (i is an integer 1 between 4) amplifies the electrical signal output from the BPD 523-i, and outputs it to the digital signal processing unit 530.

The digital signal processing unit 530 includes analog-to-digital converters (ADCs) 531-1 to 531-4, a demodulation digital signal processing unit 532, a demapping unit 533, and a decoding unit 534.

The ADC 531-i (i is an integer 1 between 4) converts the electrical signal output from the amplifier 524-i from an analog signal to a digital signal, and outputs it to the demodulation digital signal processing unit 532.

The demodulation digital signal processing unit 532 receives, as inputs, the I component of the X-polarized reception signal from the ADC 531-1, the Q component of the X-polarized reception signal from the ADC 531-2, the I component of the Y-polarized reception signal from the ADC 531-3, and the Q component of the Y-polarized reception signal from the ADC 531-4. The demodulation digital signal processing unit 532 performs signal processing such as at least an equalization process, frequency offset, and wavelength dispersion compensation on each input signal. The demodulation digital signal processing unit 532 is an aspect of a signal processing device.

The demapping unit 533 determines the symbol of the reception signal output by the demodulation digital signal processing unit 532 and converts the determined symbol into binary data.

The decoding unit 534 performs an error correction decoding process such as FEC on the binary data demapped by the demapping unit 533 to obtain a received bit string.

Meanwhile, although the above embodiment describes an example of a single optical fiber transmission path, the same applies to spatially multiplexed transmission systems (for example, multi-core fiber, multi-mode fiber, and free space transmission).

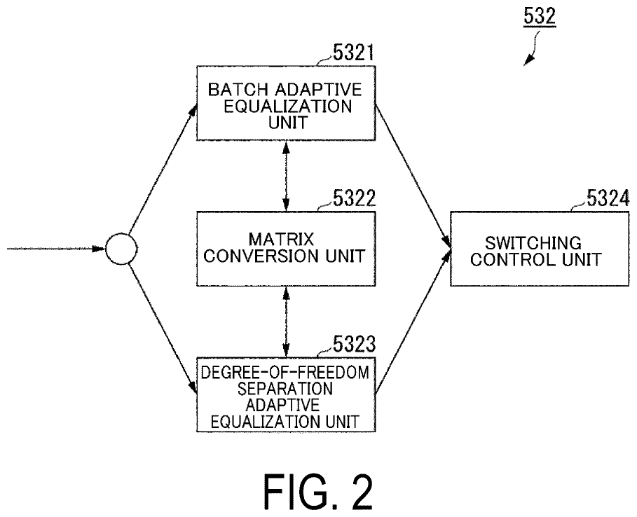

Next, the configuration of the demodulation digital signal processing unit 532 will be described. FIG. 2 is a diagram illustrating an example of a configuration of the demodulation digital signal processing unit 532 in the first embodiment. The demodulation digital signal processing unit 532 includes a batch adaptive equalization unit 5321, a matrix conversion unit 5322, a degree-of-freedom separation adaptive equalization unit 5323, and a switching control unit 5324.

The digital signal output from the ADC 531-i is input to the batch adaptive equalization unit 5321. The batch adaptive equalization unit 5321 adaptively performs an equalization process on each input signal (each digital signal). For example, the batch adaptive equalization unit 5321 performs an equalization process of waveform distortion using a first adaptive filter. The first adaptive filter is an adaptive filter used in any of the conventional 2×2 MIMO configuration, 4×2 MIMO configuration, and 8×2 MIMO configuration. The batch adaptive equalization unit 5321 outputs filter coefficients obtained in the procedure of an adaptive equalization process to the matrix conversion unit 5322.

The matrix conversion unit 5322 appropriately converts the transceiver characteristics obtained by calculation using the filter coefficients output from the batch adaptive equalization unit 5321 into a form applicable to the degree-of-freedom separation adaptive equalization unit 5323 and outputs it to the degree-of-freedom separation adaptive equalization unit 5323. Here, the form applicable to the degree-of-freedom separation adaptive equalization unit 5323 represents the determinants of Equations (9) to (11) which will be described later. That is, the matrix conversion unit 5322 converts the transceiver characteristics obtained by calculation using the filter coefficients output from the batch adaptive equalization unit 5321 into the determinants of Equations (9) to (11) which will be described later. In this way, the matrix conversion unit 5322 acquires filter coefficients of the adaptive filter used by the batch adaptive equalization unit 5321 from at least the batch adaptive equalization unit 5321, and converts the acquired filter coefficients through matrix operation.

The digital signal output from the ADC 531-i and the transceiver characteristics output from the matrix conversion unit 5322 are input to the degree-of-freedom separation adaptive equalization unit 5323. The degree-of-freedom separation adaptive equalization unit 5323 uses the transceiver characteristics input from the matrix conversion unit 5322 to perform, on the digital signal, the adaptive equalization process in which followability is high and the transceiver IQ distortion characteristics can be simultaneously compensated for. For example, the degree-of-freedom separation adaptive equalization unit 5323 uses a second adaptive filter including the filter coefficients converted by the matrix conversion unit 5322 to perform, on the each polarized digital signal, the equalization process of waveform distortion due to polarization state fluctuations in the transmission path.

The switching control unit 5324 selects either a signal equalized by the batch adaptive equalization unit 5321 or a signal equalized by the degree-of-freedom separation adaptive equalization unit 5323 as a final reception signal on the basis of an elapsed time, the quality of an equalized signal, or a signal from outside the receiver 50, and outputs the selected signal to the demapping unit 533.

The switching control unit 5324 may select either a signal equalized by the batch adaptive equalization unit 5321 or a signal equalized by the degree-of-freedom separation adaptive equalization unit 5323 as a final reception signal, for example, on the basis of the following conditions. Meanwhile, the following is an example and may be selected in other methods.
Basically, in order to increase the speed of following polarization fluctuations, a signal equalized by the degree-of-freedom separation adaptive equalization unit 5323 is preferentially selected.
Immediately after the startup of a transceiver when filter coefficients are not obtained, or the like, a signal equalized by the batch adaptive equalization unit 5321 is selected.

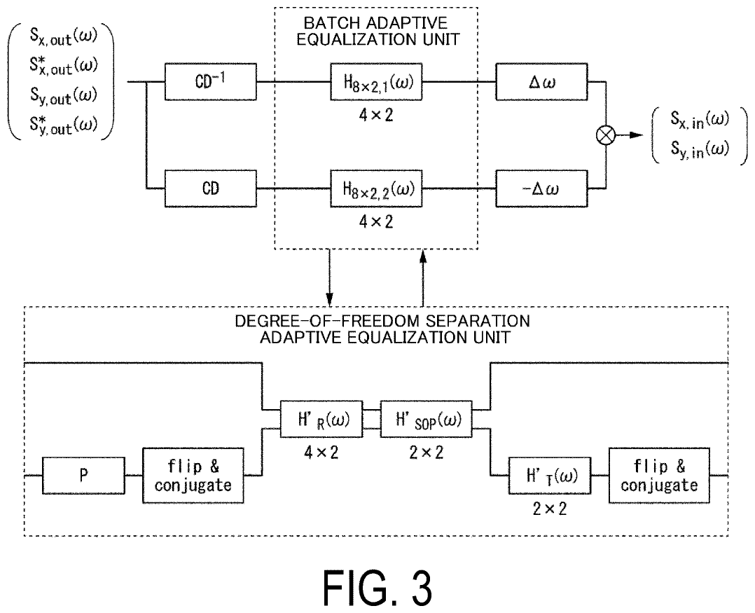

FIG. 3 is a diagram illustrating an overview of processing of the demodulation digital signal processing unit 532 in the first embodiment. In the demodulation digital signal processing unit 532 in the first embodiment, the coefficients of the adaptive equalization filter are represented as the product of a matrix indicating the degree of freedom of polarization state fluctuation and a matrix indicating the degree of freedom obtained by subtracting the polarization state fluctuation from the degree of freedom of the transceiver characteristics, and the components of the matrix indicating the degree of freedom of polarization state fluctuation are updated. This makes it possible to reduce the substantial degree of freedom during updating, to increase the maximum step size for stable operation, and to follow rapid dynamic fluctuations in the polarization state.

In FIG. 3, an 8×2 MIMO configuration operating in the frequency domain is shown as an example. The specific configuration of an 8×2 MIMO configuration operating in the frequency domain is described in Reference Literature 1, and thus the description thereof will be omitted.
(Reference Literature 1: M. Nakamura, T. Kobayashi, F. Haniaoka, and Y. Miyamoto, “High Information Rate of 128-GBaud 1.8-Tb/s and 64-GBaud 1.03-Tb/s Signal Generation and Detection Using Frequency-Domain 8×2 MIMO Equalization,” in Proceedings of Optical Fiber Communication Conference 2022, San Diego, United States, 2022, paper M3H.1.)

In FIG. 3, S_{x,in}(ω) represents the X-polarized input signal. S_{y,in}(ω) represents the Y-polarized input signal, S_{x,out}(ω) represents the X-polarized output signal, and S_{y,out}(ω) represents the Y-polarized output signal. The 8×2 MIMO configuration can be represented as in the upper part of FIG. 3 (configuration representing a batch adaptive equalization unit). Meanwhile, disregard of the lower branch (branch to CD) on the upper part of FIG. 3 is a 4×2 MIMO configuration, and disregard of the phase conjugate components (second and fourth components of the input vector) of S_{x,out}(ω) and S_{y,out}(ω) is equivalent to 2×2 MIMO. Here, CD represents wavelength dispersion compensation, and Δω,−Δω represents offset frequency compensation of local light emission. The batch adaptive equalization unit 5321 includes an adaptive filter shown in the following Equations (1) and (2).

$$[ Math . 1 ]$$

$${H}_{8 \times 2 , 1} ( ω ) := ( \begin{matrix}{h}_{xxo , 1} & {h}_{xyo , 1} & {h}_{xxc , 1} & {h}_{xyc , 1} \\ {h}_{yxo , 1} & {h}_{yyo , 1} & {h}_{yxc , 1} & {h}_{yyc , 1}\end{matrix} ) \qquad E quation ( 1 )$$

$$[ Math . 2 ]$$

$${H}_{8 \times 2 , 2} ( ω ) := ( \begin{matrix}{h}_{xxo , 2} & {h}_{xyo , 2} & {h}_{xxc , 2} & {h}_{xyc , 2} \\ {h}_{yxo , 2} & {h}_{yyo , 2} & {h}_{yxc , 2} & {h}_{yyc , 2}\end{matrix} ) \qquad E quation ( 2 )$$

The adaptive filter H_{8×2.1}(ω) and the adaptive filter H_{8×2.2}(ω) shown in Equations (1) and (2) are rewritten as in the following Equations (3) and (4) by calculation.

$$[ Math . 3 ]$$

$${H}_{8 \times 2 , 1} ( ω ) = {H}_{SOP}^{′} ( ω ) {H}_{R}^{′} ( ω ) \qquad E quation ( 3 )$$

$$[ Math . 4 ]$$

$${H}_{8 \times 2 , 2} ( ω ) = {H}_{T}^{′ *} ( - ω ) {H}_{SOP}^{′ *} ( - ω ) {H}_{R}^{′ *} ( - ω ) P \qquad Equation ( 4 )$$

Here, P in Equation (4) represents a permutation matrix, which is expressed as in the following Equation (5).

$$[ Math . 5 ]$$

$$P = ( \begin{matrix}0 & 1 & 0 & 0 \\ 1 & 0 & 0 & 0 \\ 0 & 0 & 0 & 1 \\ 0 & 0 & 1 & 0\end{matrix} ) \qquad E quation ( 5 )$$

H′_{SOP}(ω) shown in Equations (3) and (4) represents a matrix indicating the degree of freedom of polarization state fluctuation, which is expressed as in the following Equation (6).

$$[ Math . 6 ]$$

$${H}_{SOP}^{′} ( ω ) := ( \begin{matrix}{h}_{xx} ( ω ) & {h}_{xy} ( ω ) \\ {h}_{yx} ( ω ) & {h}_{yy} ( ω )\end{matrix} ) \qquad E quation ( 6 )$$

H′_{T}(ω) shown in Equation (4) represents a matrix obtained by subtracting the degree of freedom indicating the polarization state fluctuation from the degree of freedom of the transmitter 10, which is expressed as in the following Equation (7).

$$[ Math . 7 ]$$

$${H}_{T}^{′} ( ω ) := ( \begin{matrix}{h}_{T 11}^{′} ( ω ) & {h}_{T 12}^{′} ( ω ) \\ {h}_{T 21}^{′} ( ω ) & {h}_{T 22}^{′} ( ω )\end{matrix} ) \qquad Equation ( 7 )$$

H′_{R}(ω) shown in Equations (3) and (4) represents a matrix obtained by subtracting the degree of freedom indicating the polarization state fluctuation from the degree of freedom of the receiver 50, which is expressed as in the following Equation (8).

$$[ Math . 8 ]$$

$${H}_{R}^{′} ( ω ) := ( \begin{matrix}1 & {h}_{R 11}^{′} ( ω ) & 0 & {h}_{R 12}^{′} ( ω ) \\ 0 & {h}_{R 21}^{′} ( ω ) & 1 & {h}_{R 22}^{′} ( ω )\end{matrix} ) \qquad E quation ( 8 )$$

each component of H′_{SOP}(ω), H′_{T}(ω), and H′_{R}(ω) can be obtained as in the following Equations (9) to (11) using each component of H_{8×2.1}(ω) and H_{8×2.2}(ω).

$$[ Math . 9 ]$$

$${H}_{SOP}^{′} ( ω ) = ( \begin{matrix}{h}_{xxo , 1} ( ω ) & {h}_{xyo , 1} ( ω ) \\ {h}_{yxo , 1} ( ω ) & {h}_{yyo , 1} ( ω )\end{matrix} ) \qquad E quation ( 9 )$$

$$[ Math . 10 ]$$

$${H}_{T}^{′} ( ω ) = ( \begin{matrix}{h}_{xxc , 2}^{*} ( - ω ) & {h}_{xyc , 2}^{*} ( - ω ) \\ {h}_{yxc , 2}^{*} ( - ω ) & {h}_{yyc , 2}^{*} ( - ω )\end{matrix} ) {H}_{SOP}^{′ - 1} ( ω ) \qquad E quation ( 10 )$$

$$[ Math . 11 ]$$

$$( \begin{matrix}{h}_{R 11}^{′} ( ω ) & {h}_{R 12}^{′} ( ω ) \\ {h}_{R 21}^{′} ( ω ) & {h}_{R 22}^{′} ( ω )\end{matrix} ) = {H}_{SOP}^{′ - 1} ( ω ) ( \begin{matrix}{h}_{xxc , 1} ( ω ) & {h}_{xyc , 1} ( ω ) \\ {h}_{yxc , 1} ( ω ) & {h}_{yyc , 1} ( ω )\end{matrix} ) \qquad E quation ( 11 )$$

By using Equations (9) to (11) above, as described below, it is possible to perform adaptive equalization that achieves both resistance to IQ waveform distortion and followability to high-speed polarization fluctuations.

The flow of processing the demodulation digital signal processing unit 532 in the first embodiment will be described with reference to FIGS. 2 and 3. Here, a situation in which rapid polarization state fluctuations may occur due to factors such as lightning strikes or shocks associated with facility construction can be assumed. First, the ADCs 531-1 to 531-4 output a digital signal obtained by performing analog-to-digital conversion on a reception signal to the demodulation digital signal processing unit 532. The demodulation digital signal processing unit 532 inputs the real-number component XI and imaginary-number component XQ of the X-polarized reception signal converted into a digital signal by the ADCs 531-1 to 531-4 and the real-number component YI and imaginary-number component YQ of the Y-polarized reception signal.

The demodulation digital signal processing unit 532 stores each of the input real-number component XI, imaginary-number component XQ, real-number component YI, and imaginary-number component YQ in a corresponding buffer. The demodulation digital signal processing unit 532 uses the real-number component XI, the imaginary-number component XQ, the real-number component YI, and the imaginary-number component YQ stored in the buffer to calculate complex signals S_{x,out} and S_{y,out}, or S*_{x,out} and S*_{y,out} which are complex conjugates of the complex signals S_{x,out} and S_{y,out}. Here, Sₓ is equivalent to XI+iXQ, and S_{y} is equivalent to YI+iYQ. Hereinafter, S*_{x,out} and S*_{y,out} are referred to as complex conjugate signals S*_{x,out} and S*_{y,out}, respectively.

The demodulation digital signal processing unit 532 performs N-point (N is a natural number) discrete Fourier transform or fast Fourier transform on each of the calculated complex signals S_{x,out} and S_{y,out} and the complex conjugate signals S*_{x,out} and S*_{y,out}. In this way, the demodulation digital signal processing unit 532 converts the real-number component and the imaginary-number component of each polarization into a frequency domain signal. That is, the demodulation digital signal processing unit 532 generates the frequency domain component of the complex signal S_{x,out}, the frequency domain component of S_{y,out}, the frequency domain component of S*_{x,out}, the frequency domain component of S*_{y,out}. The demodulation digital signal processing unit 532 inputs the generated frequency domain component of the complex signal S_{x,out}, the generated frequency domain component of S_{y,out}, the generated frequency domain component of S*_{x,out}, the generated frequency domain component of S*_{y,out}.

The demodulation digital signal processing unit 532 branches each input frequency domain signal and performs an arithmetic operation (“multiply by CD⁻¹ or CD” in FIG. 3) for compensating for wavelength dispersion with respect to each frequency domain signal. The signal obtained by multiplying each frequency domain signal by CD⁻¹ is adaptively equalized by H_{8×2.1}(ω) of the batch adaptive equalization unit 5321. The signal obtained by multiplying each frequency domain signal by CD is adaptively equalized by H_{8×2.2}(ω) of the batch adaptive equalization unit 5321. The batch adaptive equalization unit 5321 outputs filter coefficients obtained in the procedure of the adaptive equalization process to the matrix conversion unit 5322.

The matrix conversion unit 5322 calculates transceiver characteristics using the filter coefficients output from the batch adaptive equalization unit 5321. The matrix conversion unit 5322 appropriately converts the calculated transceiver characteristics into a form applicable to the degree-of-freedom separation adaptive equalization unit 5323. Specifically, the matrix conversion unit 5322 converts the calculated transceiver characteristics from Equation (9) to Equation (11). The matrix conversion unit 5322 outputs information on the converted transceiver characteristics (information on Equations (9) to (11)) to the degree-of-freedom separation adaptive equalization unit 5323. The degree-of-freedom separation adaptive equalization unit 5323 uses the transceiver characteristics input from the matrix conversion unit 5322 to perform, on the digital signal, the adaptive equalization process in which followability is high and the transceiver IQ distortion characteristics can be simultaneously compensated for. The switching control unit 5324 switches between the signal equalized by the batch adaptive equalization unit 5321 and the signal equalized by the degree-of-freedom separation adaptive equalization unit 5323 to be used as a final reception signal on the basis of an elapsed time, the quality of an equalized signal, a signal from outside the receiver, or the like, outputs it to subsequent-stage processing of digital signal processing of the receiver.

The batch adaptive equalization unit 5321 operates an adaptive filter using a conventional 8×2 MIMO configuration (hereinafter referred to as “batch equalization”). The batch adaptive equalization unit 5321 outputs the equalized signal to the switching control unit 5324, and outputs the filter coefficients to the matrix conversion unit 5322. Meanwhile, the batch adaptive equalization unit 5321 may stop operation in a case where the degree-of-freedom separation adaptive equalization unit 5323 is equalizing the signal.

Although the batch equalization has a lower degree of followability than the equalization process performed by the degree-of-freedom separation adaptive equalization unit 5323, it is possible to obtain the characteristics of the transceiver while equalizing the polarization state fluctuations. Therefore, it is assumed that the filter is operated immediately after the startup of the transmitter 10 and the receiver 50 and in a case where the characteristics of the transmitter 10 and the receiver 50 have not yet obtained, or operated in a background where the degree-of-freedom separation adaptive equalization unit 5323 is operating in order to obtain the characteristics of the transmitter 10 and the receiver 50.

The matrix conversion unit 5322 uses Equations (9) to (11) describe above to calculate each component of H′_{SOP}(ω), H′_{T}(ω), and H′_{R}(ω) from each component of the adaptive filters H_{8×2.1}(ω) and H_{8×2.2}(ω) obtained by the batch equalization. The matrix conversion unit 5322 outputs information on each calculated component of H′_{SOP}(ω), H′_{T}(ω), and H′_{R}(ω) to the degree-of-freedom separation adaptive equalization unit 5323. Further, the matrix conversion unit 5322 calculates each component of H_{8×2.1}(ω) and H_{8×2.2}(ω) on the basis of each component of H′_{SOP}(ω), H′_{T}(ω), and H′_{R}(ω). The matrix conversion unit 5322 outputs information on each calculated component of H_{8×2.1}(ω) and H_{8×2.2}(ω) to the batch adaptive equalization unit 5321. In this way, the matrix conversion unit 5322 converts the filter coefficients into a format compatible with the batch adaptive equalization unit 5321 and the degree-of-freedom separation adaptive equalization unit 5323. The batch adaptive equalization unit 5321 and the degree-of-freedom separation adaptive equalization unit 5323 performs an equalization process using the filter coefficients in the format converted by the matrix conversion unit 5322.

The degree-of-freedom separation adaptive equalization unit 5323 increases the update step size, and then operates while adaptively updating the degree of freedom of H′_{SOP}(ω) (hereinafter referred to as “degree-of-freedom separation equalization”). By operating with the degree-of-freedom separation equalization, it is possible to improve followability to polarization fluctuations in a case where external factors such as lightning strikes are assumed. The degree-of-freedom separation adaptive equalization unit 5323 outputs the equalized signal to the switching control unit 5324, and outputs the filter coefficients to the matrix conversion unit 5322. Meanwhile, the degree-of-freedom separation adaptive equalization unit 5323 may stop operation in a case where the batch adaptive equalization unit 5321 is equalizing the signal.

In a case where the IQ waveform distortion characteristics within the transceiver change due to the lapse of time or degradation over time, it becomes necessary to update H′_{T}(ω) and H′_{R}(ω). In that case, the degree-of-freedom separation adaptive equalization unit 5323 may be updated again with the information obtained from the batch equalization through the matrix conversion unit 5322. The degree-of-freedom separation adaptive equalization unit 5323 may independently update H′_{T}(ω) and H′_{R}(ω) using a gradient descent method or the like. The timing at which H′_{T}(ω) and H′_{R}(ω)H′_{R}(ω) are updated may be the lapse of a certain period of time. The quality of the equalized signal may be monitored and the update timing may be determined on the basis of the quality. The coefficient update in the degree-of-freedom separation equalization may be performed using a gradient descent method or the like.

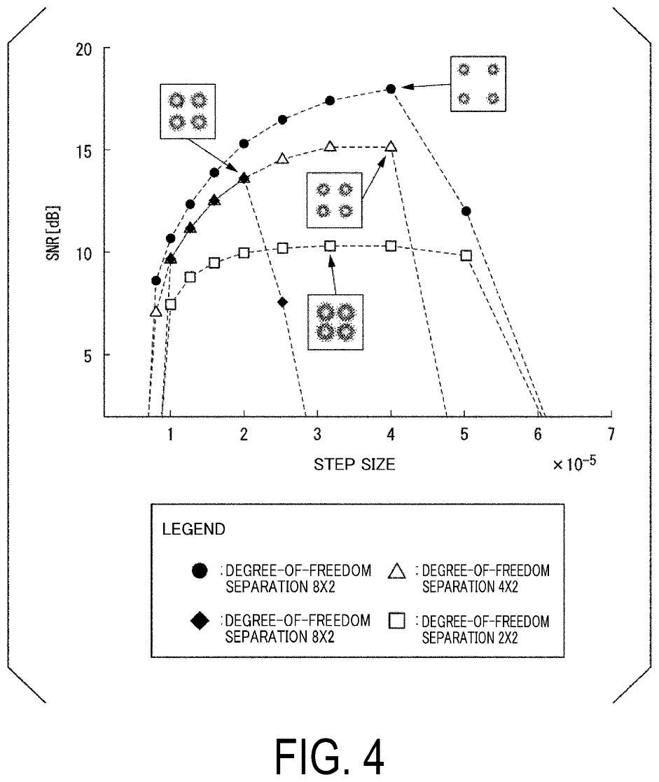

FIG. 4 is a diagram illustrating experimental results of the demodulation digital signal processing unit 532 in the first embodiment.

The example shown in FIG. 4 shows the results of an experiment conducted under the following conditions.

### (Conditions on Transmission Side)

An optical signal was generated with a modulation rate of 128 GBaud, a modulation scheme of quadrature phase shift keying (QPSK), and the number of symbols per frame of 65336, and polarization disturbance was added to the optical signal at a maximum rate of 11.01 Mrad/s using a polarization scrambler.

### (Conditions on Reception Side)

Demodulation was performed using an adaptive filter with an 8×2 MIMO scheme operating with 2×2, 4×2, and 8×2 degree-of-freedom separation equalization in frequency domain operation. For degree-of-freedom separation MIMO operation. H′_{T}(ω) and H′_{R}(ω) were measured in advance using 50 frames worth of signals. The signal-to-noise ratio (SNR) was evaluated for each frame, and the lowest SNR in 10 consecutive frames was defined as the measured SNR.

In the example shown in FIG. 4, the FFT size used during demodulation was fixed at 1024, and demodulation was performed with various step sizes for comparison. In general, if the step size is too small, the SNR is low because the polarization fluctuation cannot be followed, and if the step size is increased, the SNR is improved. However, if the step size is too large, the operation of the filter becomes unstable, and the SNR starts to decrease again. The 8×2 MIMO scheme operating with degree-of-freedom separation equalization can increase the step size at the limit of instability by about twice as large as that of the conventional 8×2 MIMO. As compared with a 2×2 MIMO configuration or a 4×2 MIMO configuration, IQ waveform distortion at both transmission and reception ends can be compensated for. Therefore, it can be seen that degree-of-freedom separation equalization 8×2 MIMO which is the proposed configuration achieves the highest SNR.

The receiver 50 configured as described above includes the batch adaptive equalization unit 5321 that uses an adaptive filter to perform equalization of waveform distortion caused by the transceiver and the transmission path, the degree-of-freedom separation adaptive equalization unit 5323 that performs equalization of waveform distortion due to fluctuations in the transmission path, the matrix conversion unit 5322 that acquires the filter coefficients of the adaptive filter from the batch adaptive equalization unit 5321, converts the acquired filter coefficients into a format compatible with the degree-of-freedom separation adaptive equalization unit 5323 through matrix operation, and outputs the converted filter coefficients to the degree-of-freedom separation adaptive equalization unit 5323, and the switching control unit 5324 that selects a signal equalized by either the batch adaptive equalization unit 5321 or the degree-of-freedom separation adaptive equalization unit 5323. This makes it possible to perform adaptive equalization having followability to rapid dynamic fluctuation in the polarization state mainly originating front the transmission path while maintaining resistance to IQ waveform distortion of the transceiver by decomposing the degree of freedom of the adaptive equalizer into the form of a matrix product, appropriately fixing the matrix part for IQ characteristics using the transceiver of the degree-of-freedom separation adaptive equalization unit 5323, and adaptively updating the matrix part representing the polarization state fluctuation component of the transmission path.

### Modification Example 1 of First Embodiment

In order to reduce the influence of noise, the matrix conversion unit 5322 may average the adaptive equalization filter coefficients acquired at a plurality of times before the matrix operation is performed.

### Modification Example 2 of First Embodiment

Although the adaptive filters used by the batch adaptive equalization unit 5321 and the degree-of-freedom separation adaptive equalization unit 5323 are filters operating in the frequency domain, these filters may be filters operating in the time domain.

### Modification Example 3 of First Embodiment

In the above-described embodiment, another adaptive equalization configuration having a function of compensating for IQ waveform distortion of the transceiver, for example, a 4×2 MIMO configuration may be used as the portion having a 8×2 MIMO configuration.

### Modification Example 4 of First Embodiment

Although a configuration in which the demodulation digital signal processing unit 532 uses the complex signals S_{x,out} and S_{y,out} and the complex conjugate signals S*_{x,out} and S*_{y,out} is shown in the above-described embodiment, the demodulation digital signal processing unit 532 may use the real-number component XI, the imaginary-number component XQ, the real-number component YI, and the imaginary-number component YQ as they are. In this case, the above-described equations cannot be used as they are, but equivalent equations can be obtained by performing base conversion operations corresponding to the vectors and matrices of the above-described equations.

### Second Embodiment

In a second embodiment, a description will be given of a configuration in which the coefficients are updated with a low frequency resolution when updating the coefficients corresponding to the degree of freedom of polarization state fluctuation in order to improve the SNR. Meanwhile, the second embodiment differs from the first embodiment in the processing performed by the degree-of-freedom separation adaptive equalization unit. The differences will be described below.

In a case where there is a signal reflection or the like in an electronic circuit inside the transceiver, the frequency characteristics of the transceiver, that is, H′_{T}(ω) and H′_{R}(ω), may have a finer structure on the frequency axis than H′_{SOP}(ω). In that case, in order to sufficiently compensate for this influence, it is necessary to increase the frequency resolution of the adaptive filter, that is, to compensate for a signal within a wider time window in the time domain. For the adaptive filter operating in the frequency domain, this is equivalent to increasing the FFT size.

However, a larger time window causes more noise components to enter the time window, and there is a tradeoff in which the SNR of the equalized signal decreases. Consequently, the degree-of-freedom separation adaptive equalization unit 5323 in the second embodiment improves the SNR of the equalized signal by updating H′_{SOP}(ω) with a low frequency resolution while keeping the frequency resolutions of H′_{T}(ω) and H′_{R}(ω) high. In a case where there is a reflection, the required time width may actually be about 10 to 100 times wider. Consequently, for example, the degree-of-freedom separation adaptive equalization unit 5323 updates H′_{SOP}(ω) with a frequency resolution of about 1/100 to 1/10 at the minimum.

Operating an adaptive filter in the frequency domain can be considered below. It is assumed that a gradient descent method is used to update coefficients in degree-of-freedom separation equalization. The update equation in this case can be represented as the following Equation (12).

$$[ Math . 12 ]$$

$${H}_{SOP}^{′} ( m + 1 ) = {H}_{SOP}^{′} ( m ) + μ ( e exp ( - i Δω t ) {s}_{1}^{†} + {H}_{T}^{′ †} ( ω ) e exp ( i Δ ω t ) {s}_{2}^{†} ) \qquad Equation ( 12 )$$

The degree-of-freedom separation adaptive equalization unit 5323 performs inverse Fourier transform once before updating the second term on the right side of Equation (12), and sets an appropriate time window in the time domain. That is, the degree-of-freedom separation adaptive equalization unit 5323 multiplies an appropriate step function or a window function such as a triangular window, and further performs Fourier transform. This makes it possible to update H′_{SOP}(ω) with a low frequency resolution. Meanwhile, when operating in the time domain, the resolution may be limited by directly multiplying e, s₁, and s₂ by a window function.

According to the receiver 50 in the second embodiment configured as described above, by updating the coefficients corresponding to the degree of freedom of polarization state fluctuation with a low frequency resolution, it is possible to limit noise component during the updating. Therefore, it is possible to improve the SNR.

Some of the functional units of the receiver 50 in the above-described embodiment may be realized by a computer. In that case, this function may be realized by recording a program for realizing the function in a computer-readable recording medium, and causing a computer system to read and execute the program recorded in this recording medium. Meanwhile, the “computer system” referred to herein includes an OS and hardware such as peripheral equipment.

In addition, the “computer-readable recording medium” includes a portable medium such as a flexible disk, magneto-optical disk, a read only memory (ROM) and a CD-ROM, and various storage apparatuses such as a hard disk built into a computer system. Further, the “computer-readable recording medium” may also include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system serving as a server or a client in such a case. In addition, the program may be a program for realizing some of the above-described functions, may be a program capable of realizing the above-described functions in a combination with a program already recorded on the computer system, or may be a program realized using hardware such as a field programmable gate array (FPGA).

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention can be applied to a technique of receiving a polarization-multiplexed signal in digital coherent optical transmission.

### REFERENCE SIGNS LIST

10 Transmitter
30 Optical fiber transmission path
50 Receiver
100 Transmission unit
110 Digital signal processing unit
111 Encoding unit
112 Mapping unit
113 Training signal insertion unit
114 Frequency change unit
115 Waveform shaping unit
116 Pre-equalization unit
117-1 to 117-4 Digital-to-analog converter (DAC)
120 Modulator driver
121-1 to 121-4 Amplifier
130 Light source
140 Integration module
141-1, 141-2 IQ modulator
142 Polarization synthesis unit
500 Reception unit
510 Local oscillation light source
520 Optical front end
521 Polarization separation unit
522-1, 522-2 Optical 90-degree hybrid coupler
523-1 to 523-4 BPD
524-1 to 524-4 Amplifier
530 Digital signal processing unit
531-1 to 531-4 Analog-to-digital converter
532 Demodulation digital signal processing unit
533 Demapping unit
534 Decoding unit
5321 Batch adaptive equalization unit
5322 Matrix conversion unit
5323 Degree-of-freedom separation adaptive equalization unit
5324 Switching control unit

1. A signal processing device comprising:
a batch adaptive equalizer configured to use a first adaptive filter to perform an equalization process of waveform distortion on each polarized digital signal obtained by performing analog-to-digital conversion on a polarization-multiplexed signal;
a matrix converter configured to acquire filter coefficients of the first adaptive filter from at least the batch adaptive equalizer, and convert acquired the filter coefficients through matrix operation;
a degree-of-freedom separation adaptive equalizer configured to use a second adaptive filter including the filter coefficients converted by the matrix converter to perform an equalization process of waveform distortion due to polarization state fluctuation in a transmission path on each polarized digital signal; and
a switching controller configured to select a signal equalized by the batch adaptive equalizer or the degree-of-freedom separation adaptive equalizer as a reception signal.

2. The signal processing device according to claim 1, wherein the degree-of-freedom separation adaptive equalizer performs an equalization process using, as the second adaptive filter, a filter of which filter coefficients are represented as a product of a matrix indicating a degree of freedom of polarization state fluctuation and a matrix indicating a degree of freedom obtained by subtracting the polarization state fluctuation from a degree of freedom of transceiver characteristics.

3. The signal processing device according to claim 1, wherein the degree-of-freedom separation adaptive equalizer updates the filter coefficients of the second adaptive filter with a low frequency resolution when updating coefficients corresponding to the degree of freedom of the polarization state fluctuation.

4. The signal processing device according to claim 1, wherein the switching controller selects any of the signals equalized by the batch adaptive equalizer or the degree-of-freedom separation adaptive equalizer as the reception signal on the basis of an elapsed time, a quality of an equalized signal, or a signal from outside.

5. A signal processing method comprising:
using a first adaptive filter to perform an equalization process of waveform distortion on each polarized digital signal obtained by performing analog-to-digital conversion on a polarization-multiplexed signal;
acquiring filter coefficients of at least the first adaptive filter, and converting acquired the filter coefficients through matrix operation;
using a second adaptive filter including the converted filter coefficients to perform an equalization process of waveform distortion due to polarization state fluctuation in a transmission path on each polarized digital signal; and
selecting a signal that has undergone the equalization process using the first adaptive filter or the equalization process using the second adaptive filter as a reception signal.

6. A non-transitory storage medium that stores a program for making a computer perform processes, the processes comprising:
using a first adaptive filter to perform an equalization process of waveform distortion on each polarized digital signal obtained by performing analog-to-digital conversion on a polarization-multiplexed signal;
acquiring filter coefficients of at least the first adaptive filter and converting acquired the filter coefficients through matrix operation;
using a second adaptive filter including the converted filter coefficients to perform an equalization process of waveform distortion due to polarization state fluctuation in a transmission path on each polarized digital signal; and
selecting a signal that has undergone the equalization process using the first adaptive filter or the equalization process using the second adaptive filter as a reception signal.
